(19) United States
(12) Patent Application Publication
(10) Pub. No.: US 2025/0145802 A1
(43) Pub. Date: May 8, 2025

(54) CLOTHING FABRIC COMPOSITION

(71) Applicant: Dallas Leanne Powers, Cochrane (CA)

(72) Inventor: Dallas Leanne Powers, Cochrane (CA)

(21) Appl. No.: 18/503,531

(22) Filed: Nov. 7, 2023

(51) Int. Cl. C08L 1/02

(52) U.S. Cl. CPC C08L 1/02

(57) ABSTRACT

A clothing material composition wherein the clothing material composition of the present invention is utilized to manufacture clothing of various styles and sizes wherein the clothing is primarily activewear type clothing. The composition of the present invention produces a moisture evaporation time from a saturation point that is approximately twenty percent faster than conventional fabrics having bamboo viscose in the blend thereof. The present invention in a preferred embodiment employs a fabric composition having at least ninety percent bamboo viscose wherein the preferred range within the scope of the present invention is ninety to ninety-five percent bamboo viscose. The remaining composition of the present invention can be comprised of any combination of the following: cotton, lycra, spandex, nylon, polyester or wool.

### FIELD OF THE INVENTION

The present invention relates generally to clothing materials, more specifically but not by way of limitation, a clothing material composition that is operable provide characteristics such as but not limited to durability, temperature control, moisture control and reduce odor capture wherein the clothing material of the present invention is configured to have at least ninety percent bamboo.

### BACKGROUND

A recent trend in the activewear clothing industry is to focus on performance fabrics that provide a plurality of benefits to the wearer. One recent trend using natural materials has emerged, with bamboo-based clothing being one of the leading contenders in recent years. The benefits of bamboo clothing are claimed that it has a lower impact on the environment, but also that clothes made from bamboo provide other features such as comfort and exceptional odor control. Most clothing marketed as bamboo is made using bamboo rayon (known as bamboo viscose) which means it has been processed until it no longer possesses any trace of the original plant. The bamboo rayon is then typically blended with other fabrics, such as cotton, merino wool or elastane to give it other properties, such as increased breathability or stretch. Another benefit to bamboo is it is more odor resistant than other fabrics.

There are intrinsic benefits to bamboo clothing such as but not limited to that bamboo clothing is considered to be the softest and most comfortable against a wearer's skin. Bamboo based clothing further excels against other fabrics in the area of breathability. Bamboo rayon absorbs the moisture from your skin unlike synthetic fabrics such as nylon and polyester which repel moisture. This helps a wearer regulate their temperature. Bamboo based fabric is environmentally desirable as bamboo is a naturally high yield and requires fewer industrial resources to harvest and is cut like a grass leaving the roots in the ground to regrow. Bamboo is a dense product which results in less soil erosion and requires less space for growth. While clothing material with bamboo has been proven effective, the current technology of blending produces a fabric with inferior results for moisture control.

Accordingly, there is a need for a clothing material composition that employs bamboo wherein the clothing material provides improved moisture control and limits utilization of the amount of other fabric material blended thereinto.

### SUMMARY OF THE INVENTION

It is the object of the present invention to provide a clothing material composition that provides improved moisture control wherein the clothing material composition of the present invention is employed to manufactured a multitude of alternate styles of men's, women's and children's clothing.

Another object of the present invention is to provide a fabric that is operable to provide benefits such as but not limited to reduced odor absorption, improved moisture control and durability wherein the fabric of the present invention is comprised of at least ninety percent bamboo viscose.

A further object of the present invention is to provide a clothing material composition that provides improved moisture control wherein the clothing material composition of the present invention is blended with alternate materials such as but not limited to spandex or rayon.

Yet a further object of the present invention is to provide a fabric that is operable to provide benefits such as but not limited to reduced odor absorption, improved moisture control and durability wherein the fabric of the present invention is provided in a multitude of colors.

Still another object of the present invention is to provide a clothing material composition that provides improved moisture control wherein the clothing material composition demonstrates an improved ability to absorb moisture.

An additional object of the present invention is to provide a fabric that is operable to provide benefits such as but not limited to reduced odor absorption, improved moisture control and durability wherein the fabric of the present invention has an improved drying time over conventional fabrics.

Yet a further object of the present invention is to provide a clothing material composition that provides improved moisture control wherein the clothing material composition is provided in alternate weights, known as grams per square meter (GSM).

To the accomplishment of the above and related objects the present invention may be embodied in the form illustrated in the accompanying drawings. Attention is called to the fact that the drawings are illustrative only. Variations are contemplated as being a part of the present invention, limited only by the scope of the claims.

### BRIEF DESCRIPTION OF THE DRAWINGS

A more complete understanding of the present invention may be had by reference to the following Detailed Description and appended claims when taken in conjunction with the accompanying Drawings wherein:

FIG. 1 is an exemplary embodiment of a sock manufactured from the clothing material composition of the present invention; and

FIG. 2A is a front view of the exemplary embodiment of leggings manufactured from the clothing material composition of the present invention; and

FIG. 2B is a rear view of the exemplary embodiment of leggings manufactured from the clothing material composition of the present invention; and

FIG. 3 is a chart of an experiment utilizing the fabric composition of the present invention.

### DETAILED DESCRIPTION

Referring now to the drawings submitted herewith, wherein various elements depicted therein are not necessarily drawn to scale and wherein through the views and figures like elements are referenced with identical reference numerals, there is illustrated a clothing material 100 constructed according to the principles of the present invention.

An embodiment of the present invention is discussed herein with reference to the figures submitted herewith. Those skilled in the art will understand that the detailed description herein with respect to these figures is for explanatory purposes and that it is contemplated within the scope of the present invention that alternative embodiments are plausible. By way of example but not by way of limitation, those having skill in the art in light of the present teachings of the present invention will recognize a plurality of alternate and suitable approaches dependent upon the needs of the particular application to implement the functionality of any given detail described herein, beyond that of the particular implementation choices in the embodiment described herein. Various modifications and embodiments are within the scope of the present invention.

It is to be further understood that the present invention is not limited to the particular methodology, materials, uses and applications described herein, as these may vary. Furthermore, it is also to be understood that the terminology used herein is used for the purpose of describing particular embodiments only, and is not intended to limit the scope of the present invention. It must be noted that as used herein and in the claims, the singular forms “a”, “an” and “the” include the plural reference unless the context clearly dictates otherwise. Thus, for example, a reference to “an element” is a reference to one or more elements and includes equivalents thereof known to those skilled in the art. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

References to “one embodiment”, “an embodiment”, “exemplary embodiments”, and the like may indicate that the embodiment(s) of the invention so described may include a particular feature, structure or characteristic, but not every embodiment necessarily includes the particular feature, structure or characteristic.

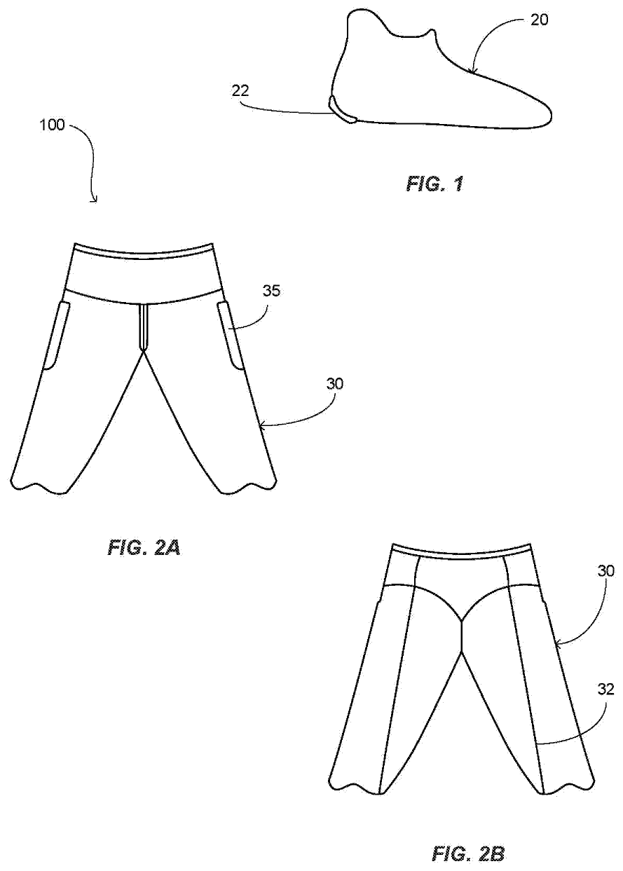

Referring in particular to the Figures submitted herewith, embodiments of the styles of clothing that can be manufactured from the clothing material 100 of the present invention are illustrated herein in FIG. 1 through FIG. 2B. It should be understood within the scope of the present invention that the clothing material 100 of the present invention could be employed to make any style and size of clothing and the illustrations submitted herewith are exemplary only and do not function to specify the style and type of clothing manufactured by the clothing material 100.

In FIG. 1 submitted as a part hereof, the clothing material 100 is utilized to make an exemplary sock 20. The sock 20 is manufactured from the clothing material 100 that has a composition of bamboo viscose that is greater than ninety percent. The sock 20 of the present invention is illustrated herein as being a mid-rise sock but it is contemplated within the scope of the present invention that the sock 20 could be manufactured as a low-rise or a high-rise sock. Sock 20 includes heel pad 22 wherein the heel pad 22 is secured to the body of the sock 20 employing suitable durable techniques. The heel pad 22 provides protection of the heel of the wearer of the sock 20 and is manufactured from the clothing material 100 of the present invention that is at least ninety percent bamboo viscose.

FIGS. 2A and 2B illustrate an exemplary pair of leggings 30 wherein the leggings 30 are manufactured from the clothing material 100 of the present invention. The leggings 30 are conventional style leggings utilized for various activities and include pocket members 35 integrally formed therein utilizing suitable techniques. The leggings 30 include seams 32 from the manufacturing process and it should be understood within the scope of the present invention that the seams 32 could be formed from suitable techniques such as but not limited to stitching or chemical adhesion. It is contemplated within the scope of the present invention that the leggings 30 could be manufactured in alternate lengths. Furthermore, it should be understood within the scope of the present invention that the leggings 30 could be provided with alternate features and further be offered in a multitude of colors and sizes.

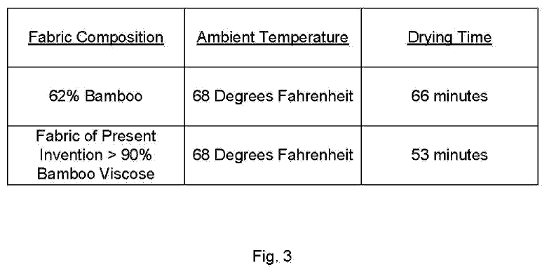

Referring in particular to FIG. 3, results of moisture evaporation of the clothing material 100 as compared to conventional fabric is outlined therein. The clothing material 100 of the present invention employing the composition of having at least ninety percent bamboo viscose demonstrates an unexpected drying time (moisture evaporation) of approximately twenty percent faster over conventional bamboo fabric which has a bamboo viscose percentage of sixty-two percent. The experiment table illustrated in FIG. 3 illustrates the two fabric compositions test, ambient temperature in which the test was approximately conducted in, and the drying time for each of the tested fabric compositions. The test was conducted utilizing a fully saturated section of each of the tested fabric compositions. It should be understood within the scope of the test that fully saturated is defined as the sample test fabric was saturated with water until the sample test fabrics could no longer absorb any additional water. Subsequent saturation of the sample test fabrics, the two test fabrics were superposed the same substrate wherein moisture amount detection was sampled at periodic intervals on both tested fabric compositions. The clothing material 100 of the test fabric having ninety percent bamboo viscose reached full evaporation of moisture at the cited ambient temperature in fifty-three minutes. The conventional fabric sample having sixty two percent bamboo viscose reached full evaporation in sixty-six minutes. The clothing material 100 composition achieved an approximately twenty percent faster evaporation rate than the conventional fabric. Common belief in the art teaches that high content bamboo viscose clothing material behaves more like cotton subsequent to becoming wet. The conventional fabric tested in the experiment described herein included twenty seven percent organic cotton and eleven percent of lycra/nylon blend. Nylon is known to repel water thus reducing the amount of water to reach saturation supporting the unexpected finding of the present invention. The fabric composition of the clothing material 100 included ten percent polyester, also a non-absorbent material. While ten percent polyester was utilized to manufactured the fabric composition of the clothing material 100, it is contemplated within the scope of the present invention that the ten percent could be comprised of other fabrics or a blend thereof. By way of example but not limitation, the ten percent could include cotton, lycra, spandex, nylon, polyester or wool.

In the preceding detailed description, reference has been made to the accompanying drawings that form a part hereof, and in which are shown by way of illustration specific embodiments in which the invention may be practiced. These embodiments, and certain variants thereof, have been described in sufficient detail to enable those skilled in the art to practice the invention. It is to be understood that other suitable embodiments may be utilized and that logical changes may be made without departing from the spirit or scope of the invention. The description may omit certain information known to those skilled in the art. The preceding detailed description is, therefore, not intended to be limited to the specific forms set forth herein, but on the contrary, it is intended to cover such alternatives, modifications, and equivalents, as can be reasonably included within the spirit and scope of the appended claims.

What is claimed is:

1. A fabric composition configured to be utilized to manufacture clothing wherein the fabric composition comprises:
ninety percent bamboo viscose;
ten percent of alternate materials blended with said ninety percent viscose.

2. The fabric composition configured to be utilized to manufacture clothing as recited in claim 1, wherein the ten percent of alternate materials is selected from at least one material from a group of materials comprised of the following materials: cotton, lycra, spandex, nylon, polyester or wool.

3. A fabric composition configured to be utilized to manufacture clothing wherein the fabric composition comprises:
a base material, said base material being bamboo viscose, said base material being ninety to ninety-five percent of the fabric composition;
an alternate material, wherein said alternate material is blended with said base material, said alternate material being five to ten percent of the fabric composition.

4. The fabric composition configured to be utilized to manufacture clothing as recited in claim 3, wherein said alternate materials are selected from at least one material from a group of materials comprised of the following materials: cotton, lycra, spandex, nylon, polyester or wool.
